(19) United States
(12) Patent Application Publication
(10) Pub. No.: US 2022/0372751 A1
(43) Pub. Date: Nov. 24, 2022

(54) INSTALLATION SYSTEM FOR PARTITION PANELS IN A ROOM

(71) Applicant: DRESSWALL S.r.l., Cantù (CO) (IT)

(72) Inventors: Luca MASCHERONI, Carimate (CO) (IT); Silvia ZOIA, Carimate (CO) (IT)

(21) Appl. No.: 17/748,480

(22) Filed: May 19, 2022

(30) Foreign Application Priority Data
May 21, 2021 (IT) 102021000013241

(51) Int. Cl. E04B 2/82

(52) U.S. Cl. CPC E04B 2/821; E04B 2/828

(57) ABSTRACT

An installation system for partition panels in a room, the system including at least one upper telescopic group, having sections and constrained to the ceiling, and at least one lower telescopic group, having sections and constrained to the floor, a series of partition panels positioned between the upper and lower telescopic groups with coupling-uncoupling groups, where both the upper telescopic group and lower telescopic group comprise a first section and a second section for coupling with each other, the second section slidingly arranged inside the first section and adjustable with respect thereto, each of the coupling-uncoupling groups comprising a first female coupling element and a second male coupling element, one connected to the second section and the other to the partition panel, which can be engaged with each other by a releasable constraint.

### BACKGROUND OF THE INVENTION

The present invention relates to an installation system for partition panels in a room.

The term “partition panel” refers to staves, profiles, wall elements, etc. that can be used in an environment for the creation of a subdivision of the environment itself into spaces intended for the most diverse uses.

There is a need for being able to divide an environment into spaces on specific request with structures that can be possibly removed, even at least partially, so as to be able to intervene to vary the form, width and type of spaces thus created and defined.

This requirement has been solved with the introduction of dividing systems with staves or panels that can be positioned between the floor and the ceiling for creating the required spaces in a simple way and that can at the same time be rapidly installed, while retaining a certain aesthetic appearance of the final environment thus created.

These systems also require the possibility of intervening simply and rapidly to remove staves or partial wall elements so as to vary the space defined for the most varied occupancy or habitability requirements of the space.

An important problem in this type of system is the installation of structural elements suitable for positioning and supporting the partition panels, as defined above, even in the presence of supporting surfaces that are not perfectly flat and level. The ceiling or the floor, for example, may not in fact be perfectly uniform and flat and in any case such that the structural elements that must be attached to them are difficult to position correctly.

The problem at the basis of the present invention is therefore that of creating an installation system for partition panels in a room that is capable of overcoming the limitations of the state of the art in a simple, reliable and economical way.

Within the context of this problem, an objective of the present invention is to provide an installation system that is capable of overcoming the problems of the non-presence of levelling and horizontal plane of the floor or ceiling.

In particular, a further objective of the present invention is to provide an installation system for partition panels in a room in the presence of a non-level floor and/or ceiling, making everything extremely simple and immediate.

A further objective of the present invention is to provide an installation system for partition panels in a room in the presence of a non-level floor and/or ceiling, which in any case also allows the simple and immediate removal of the single partition panel forming the area or partition wall.

### SUMMARY OF THE INVENTION

According to one aspect, the invention therefore relates to an installation system for partition panels in a room that includes a ceiling and a floor, wherein the system comprises, in combination:

at least one upper telescopic group, produced with sections and arranged constrained to the plane of the ceiling, and at least one lower telescopic group, produced with sections and arranged constrained to the plane of the floor, respectively;
a series of partition panels positioned between said upper and lower telescopic groups with the interpositioning of coupling-uncoupling groups;
wherein both said at least one upper telescopic group and said lower telescopic group comprise a first section and a second section destined for being internally coupled with each other, wherein said second section is slidingly arranged inside the first section and is adjustable in position with respect to the same, once said first section has been fixed to the plane of the ceiling and to the plane of the floor, respectively;
wherein each of said coupling-uncoupling units comprises a first female coupling element and a second male coupling element, one connected to said second section and the other to said partition panel which can be engaged with each other in rotation by means of releasable constraint means.

Further characteristics and advantages of the present invention will become more evident from the following detailed description of some of its preferred embodiments, made with reference to the attached drawings.

### BRIEF DESCRIPTION OF THE DRAWINGS

The different characteristics in the individual configurations can be combined with each other as desired according to the previous description, should advantage be taken of the benefits resulting specifically from a particular combination.

In said drawings,

FIG. 1 is a perspective view of a system according to the present invention in an operational configuration of parts exploded together;

FIG. 2 is a raised sectional view of the system of FIG. 1;

FIG. 3 is an exploded raised sectional side view showing a telescopic group being assembled;

FIGS. 4 and 4a are raised sectional side views in different positions when the telescopic group is assembled and adjusted from a lowered to a raised position;

FIGS. 5 to 6 show exploded and assembled perspective views of a partition panel forming part of the system of the invention;

FIGS. 7 and 8 show enlarged exploded perspective views of elements of the two female coupling elements with a male coupling element which form coupling-uncoupling groups;

FIGS. 9 and 10 show enlarged sections of a coupling-uncoupling group in its two operating positions for insertion and coupling;

FIGS. 11 to 14 show in four consecutive steps how the assembly of a system according to the invention is effected.

### DETAILED DESCRIPTION OF THE INVENTION

In the following description, for the illustration of the figures, identical reference numbers are used for indicating construction elements having the same function. Furthermore, for clarity of illustration, some numerical references may not have been repeated in all of the figures.

Indications such as “vertical” and “horizontal”, “upper” and “lower” (in the absence of other indications) should be read with reference to the assembly (or operating) conditions and referring to the normal terminology used in current language, wherein “vertical” indicates a direction substantially parallel to that of the force of gravity vector “g” and a horizontal direction perpendicular to it.

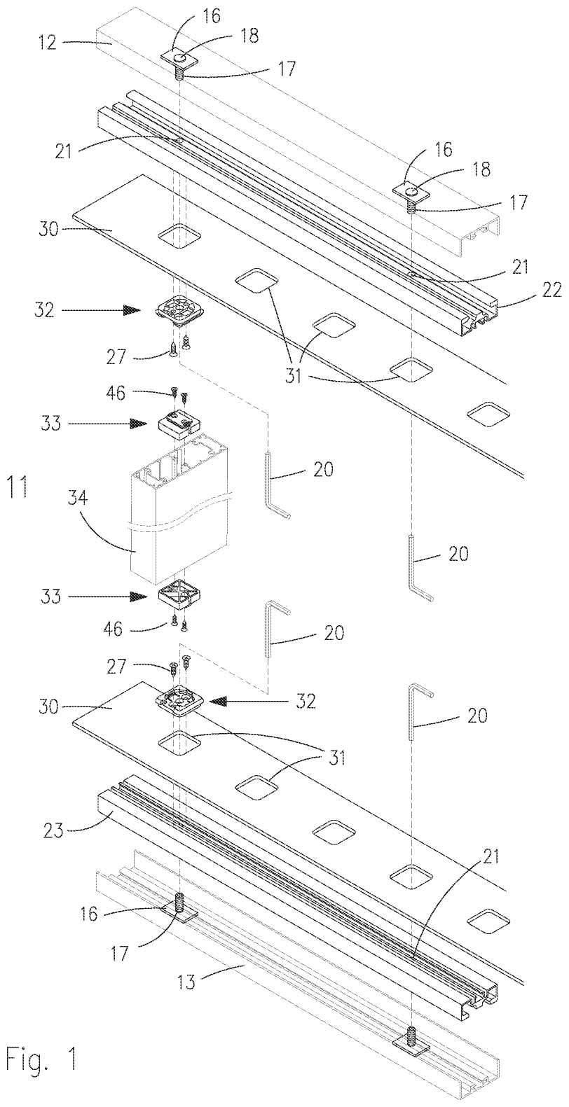

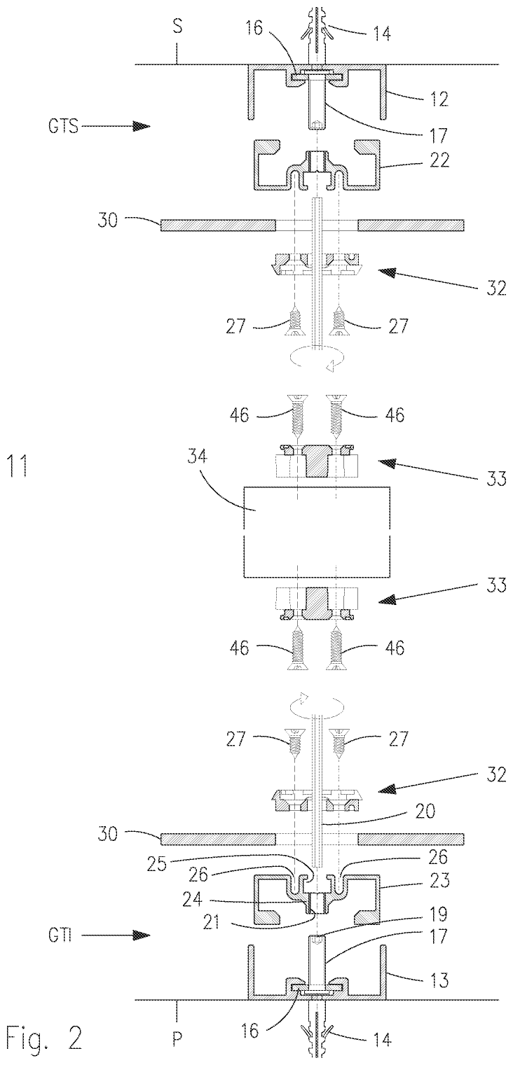

With reference to FIGS. 1 and 2, these show an embodiment of an installation system for partition panels in a room according to the present invention, indicated as a whole with 11.

This system is suitable for being arranged in an environment fixed at one end to a ceiling S and at the other end to a floor P. More specifically, there is the provision that these ends be composed of upper telescopic groups GTS and lower telescopic groups GTI produced with profiles that are fixed to the ceiling S and to the floor P and allow, according to the present invention, their adjustment with respect to the plane of the ceiling S or the plane of the floor P, in order to be able to arrange wall elements to be installed by means of the system of the present invention, level and correctly oriented.

Each telescopic group GTS, GTI comprises a first section 12, 13, for example in extruded aluminum, which has a U-shaped section. The first section 12 is constrained to the ceiling S and the first section 13 is constrained to the floor P by means of expansion dowels 14, respectively.

The first sections 12, 13, which, as already indicated, have a U-shaped section, in a central portion that connects the two sides of the U, within the section, have and carry a longitudinal shaped housing 15 with curved ends suitable for slidingly receiving plates 16 in its interior. These plates 16 carry and axially constrain, free to rotate, threaded pins 17 provided with heads 18 which protrude perpendicular to each plate 16. These threaded pins 17 are internally provided with a blind hole 19 and shaped, for example hexagonal, for receiving an Allen key 20 which allows them to rotate in screwing and/or unscrewing with respect to threaded holes 21, whose positioning is described further on.

A second section 22, 23 is internally and slidingly coupled with the first section 12, 13, to form the telescopic assembly, and this too substantially has a U-shaped section. More specifically, this second section 22, 23 also has a central shaped portion consisting of a solid central section 24 and a longitudinal shaped housing 25 with curved ends suitable for allowing the free passage of the threaded pins 17 and/or of the Allen key 20 in pass-through threaded holes 21. On opposite sides with respect to said shaped housing 25, the second section has longitudinal seats 26 for fixing screws 27.

The first section 12, 13 and the second section 22, 23 can be respectively inserted, the second in the first so as to create the above-mentioned telescopic coupling group GTS, GTI and can be adjustably moved between each other so as to be arranged at a reciprocal distance as desired, to allow the adjustment in position with respect to the ceiling S and/or to the floor P respectively of the room in which the system of the present invention must be constrained.

FIGS. 4 and 4a show the telescopic group in a raised sectional side view in two different positions when, once assembled, it is adjusted from a lowered to a raised position with the Allen key 20 which rotates the threaded pin 17, inserted in the threaded hole 21. This causes the movement of the second section 23 with respect to the first section 13 to reach the required position in height of the second section 23 with respect to the first section 13, which remains fixed to the floor P.

The same considerations made for the telescopic coupling group GTI should also be applied for the group GTS which has the possibility of having the adjustment in position between the first fixed section 12 and the second section 22 movable and adjustable in position with respect to the first section 12.

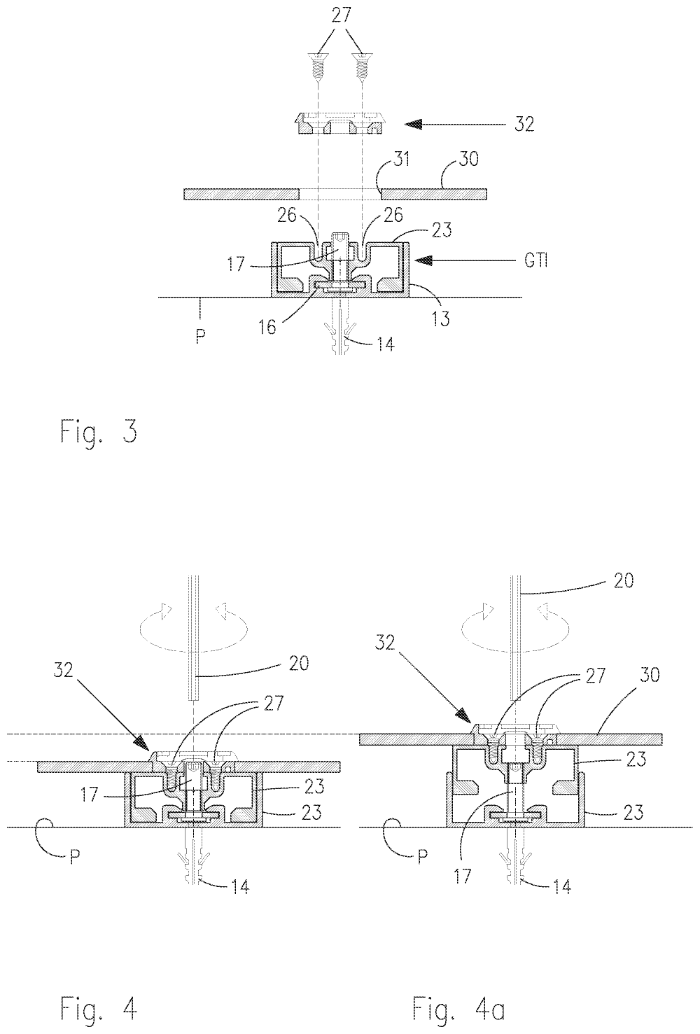

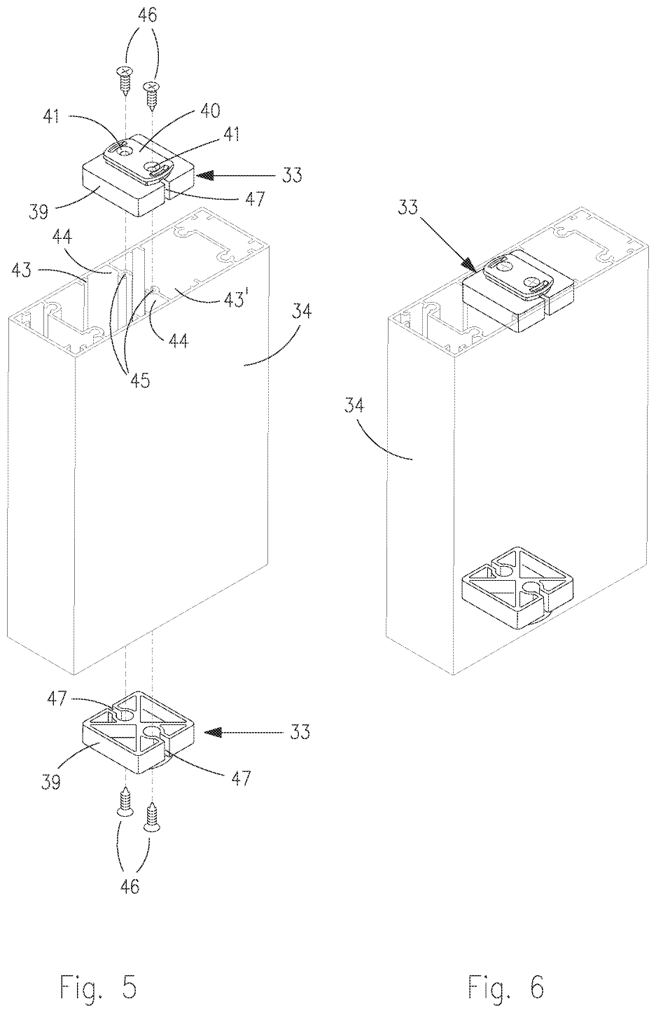

An “aesthetic” covering plate 30 is positioned above the telescopic coupling groups GTS, GTI and provides a series of pass-through openings 31 which each allow the passage of a first female coupling element 32 (FIGS. 3 and 4, 4a) for a respective second male coupling element 33 connected to a partition panel or stave 34 (FIGS. 5 and 6). As previously indicated, the term “partition panel” refers to staves, profiles, wall elements, etc. that can be used in an environment for the creation of a subdivision of the environment itself into spaces intended for the most diverse uses.

Each first female coupling element 32 with a respective second male coupling element 33 form a coupling-uncoupling group and these groups are arranged for each partition panel or stave 34 to be positioned.

Each coupling-uncoupling group comprises a first female coupling element 32 and a second male coupling element 33, one connected to said second section 22, 23 and the other to said partition panel 34 which can be engaged in rotation by releasable constraint means which are described hereunder.

The first female coupling element 32 is in fact fixed by means of the fixing screws 27 within the seats 26 of the second section 22, 23 forming part of the respective telescopic coupling group GTS, GTI.

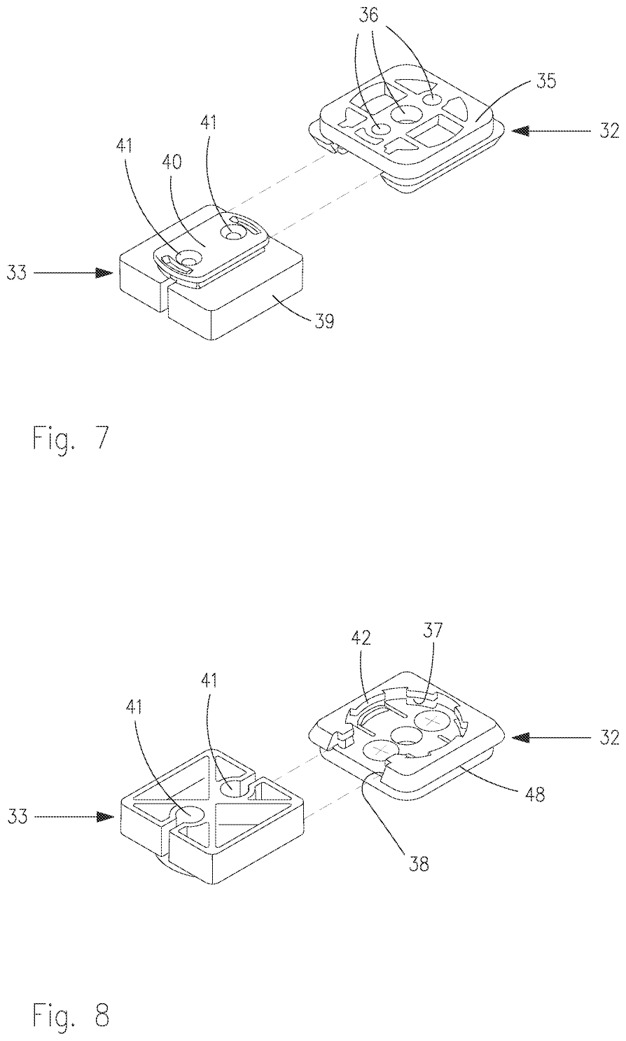

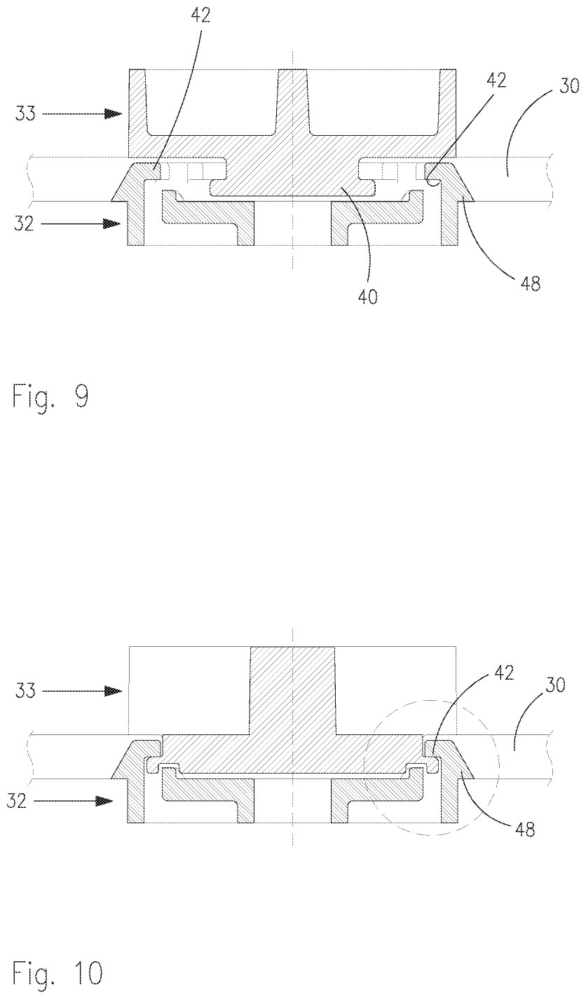

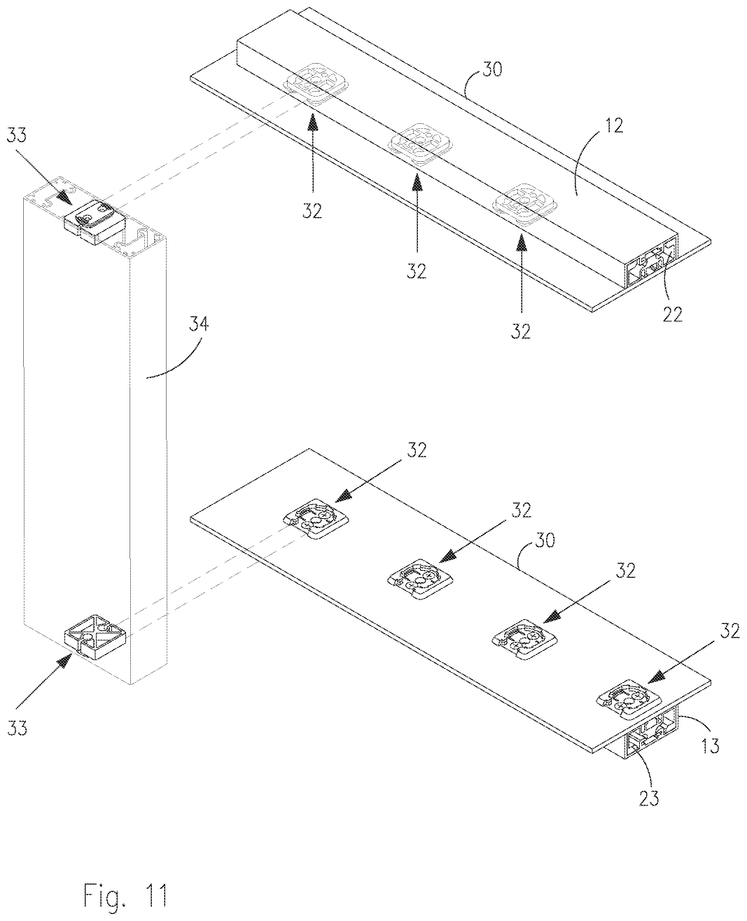

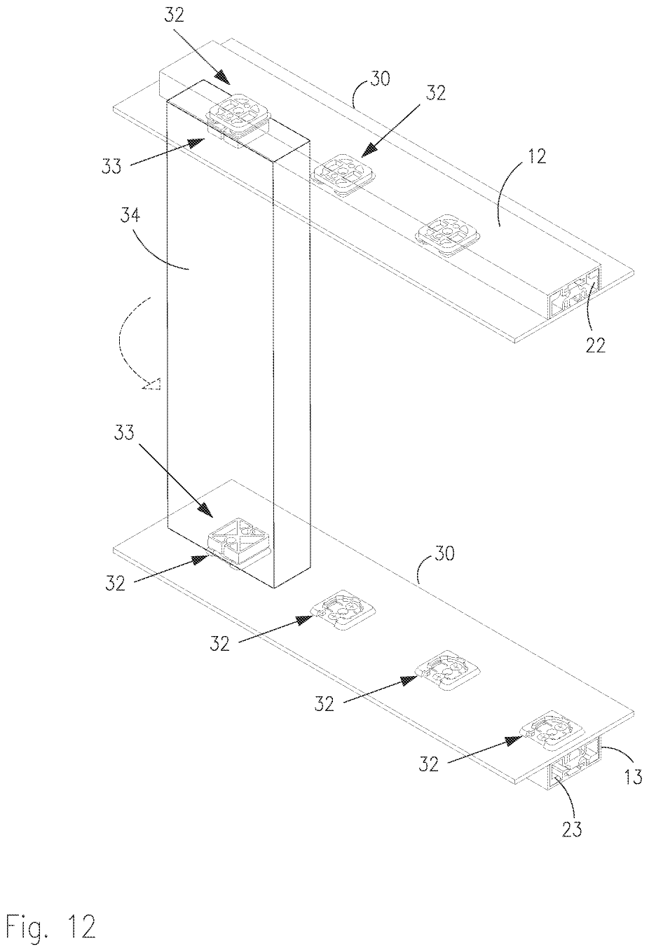

In the example shown, the first female coupling element 32 comprises a plate structure 35 whose base has three aligned pass-through holes 36 and a recessed circular housing 37, with a peripheral opening 38 for allowing access to the housing 37 (FIGS. 7 and 8). In addition, a peripheral edge 48 is also provided which protrudes outwardly and abuts against the opening 31 formed in the covering plate 30.

The second male coupling element 33 comprises a plate structure 39 from which a flat elongated rectangular T-shaped extension 40 protrudes, provided with two fixing holes 41.

The flat T-shaped extension 40 is such and suitable for passing from the peripheral access opening 38 to the housing 37 by its shorter side so as to enter the same and, by rotation, position itself blocked in its interior with its longer side beneath a perimetric edge 42 protruding inwardly, causing the blockage by rotation between the two parts or two female 32 and male 33 coupling elements. In this way a coupling-uncoupling group is created between two parts, in this case between a telescopic group GTS, GTI and a partition panel 34.

It should be noted that according to the present invention the second male coupling element 33 is inserted in a pair of seats 43, 43′ of one end of a partition panel or stave 34. In particular in the example shown, a partition panel or stave 34 is produced with an aluminum extruded element at whose ends the two seats 43, 43′, etc. are defined. In an intermediate area between these seats 43, 43′, two flaps 44 are provided with holes 45 for fixing screws 46 at the ends. The second male coupling element 33 in its plate structure 39 has two recesses 47 suitable for being wedge-inserted on the flaps 44 provided between the seats 43, 43′ of the partition panel or stave 34. Once this insertion has been effected, the second male coupling element 33 is stably fixed to the partition panel or stave 34 by screwing the fixing screws 46 into the two holes 41 and then further into the holes 45 of the flaps 44 present in the partition panel or stave 34.

These constraining operations of the second male coupling element 33 are carried out on both opposite longitudinal sides of the partition panel or stave 34. And it has been seen that an “aesthetic” covering plate 30 provided with a series of openings 31 each bearing a respective first female coupling element 32 has been previously positioned at each of the telescopic groups GTS, GTI fixed to the ceiling S and to the floor P.

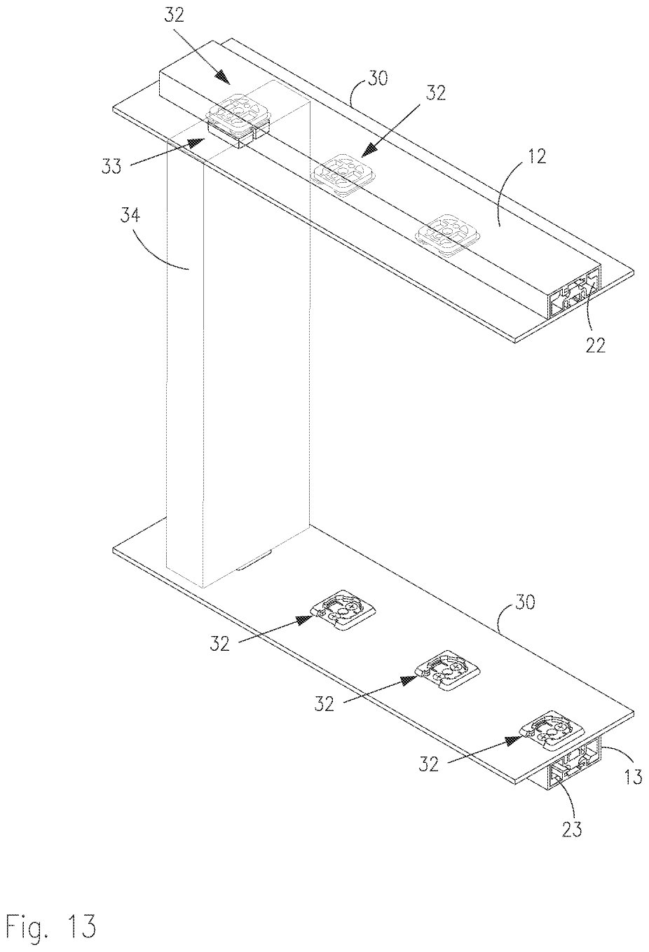

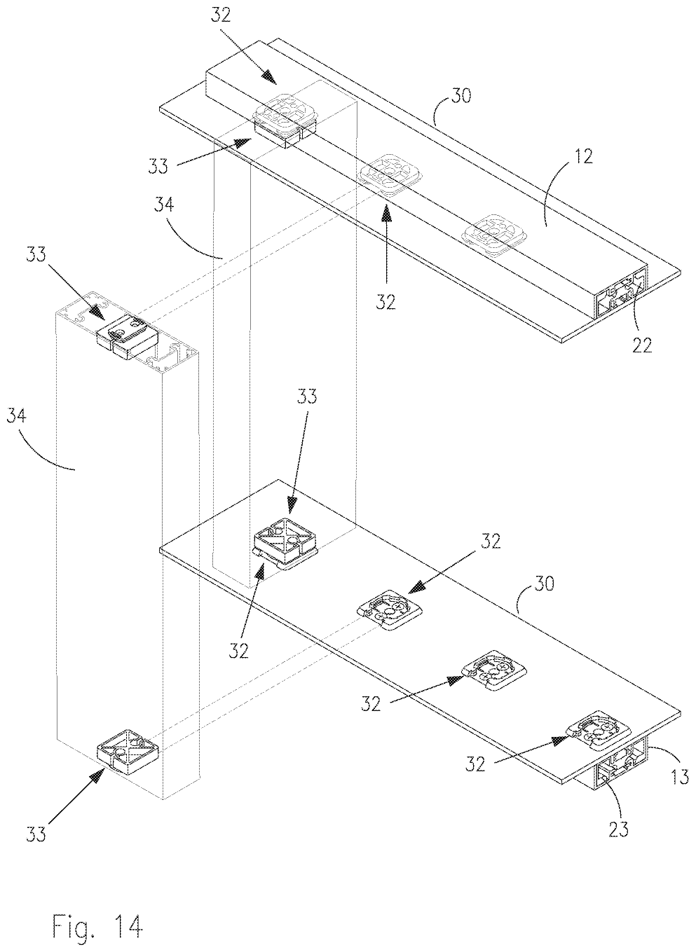

FIGS. 11 to 14 show how the positioning and fixing sequence of the series of partition panels or staves 34 takes place, that are to be positioned in the room for achieving the desired division of the room itself.

The second male coupling elements 33 fixed to the two ends of each dividing element or stave have an external shape which is inserted into a circular seat present in the first female coupling elements 32 previously fixed to the telescopic groups GTS, GTI according to the required positioning as shown in FIG. 4.

More specifically, for each dividing element 34, the T-shaped flat extension 40 of the plate structure 39 of the second male coupling element 33 is inserted, passing through the peripheral access opening 38 into the recessed circular housing 37 present in the plate structure 35 of the first female coupling element 32 integral with a telescopic group GTS, GTI.

Once this insertion has been completed, for both ends of the dividing element 34, a 90° rotation of the section of this dividing element or stave 34 is effected, fixing the same to the opposite telescopic groups GTS, GTI to the ceiling S and to the floor P. Once this coupling operation has been effected, a stable positioning of the dividing element 34 is obtained in the environment in the predetermined position. Said positioning that can be released, if necessary, by effecting the necessary rotation and uncoupling steps rapidly and almost immediately.

The blockage between the parts indicated above is achieved by means of a snap-engagement, for example by exploiting the elasticity of both the first female coupling element 32 and the second male coupling element 33 which can be made of a suitable plastic material. This material is also particularly favourable for effecting the positioning of said two coupling elements 32, 33 with respect to both ends of the single dividing element 34 and in the openings or recesses or seats present in the sections of the telescopic groups GTS, GTI.

The system according to the present invention is extremely simple to assemble and allows, as seen, the alignment and level adjustment of the telescopic groups GTS, GTI with the use of a simple Allen key. In this way, the system is adaptable even in the presence of ceilings or floors that are not perfectly level.

The positioning of the dividing elements or staves 34, which can have various forms, sizes and sections as desired, is effected in the environment in the pre-selected position thanks to the extreme ease of fixing the telescopic groups GTS, GTI.

The replacement of the dividing elements or staves 34, if necessary, for maintenance or for changing the form, is extremely easy and immediate thanks to the presence in the system of the coupling-uncoupling groups 32, 33.

The characteristics of the system object of the present invention are evident from the above description, as also the relative advantages.

From the embodiments described above, further variants are possible, without departing from the disclosure of the invention.

Finally, it is evident that a system thus conceived can undergo numerous modifications and variations, all of which are within the scope of the invention; furthermore, all the details can be replaced by technically equivalent elements. In practice, the materials used, as also the dimensions, can vary according to the technical requirements.

1. An installation system for partition panels in a room that includes a ceiling and a floor, wherein the system comprises in combination:
at least one upper telescopic group, produced with sections and arranged constrained to the plane of the ceiling, and at least one lower telescopic group, produced with sections and arranged constrained to the plane of the floor respectively;
a series of partition panels positioned between said upper and lower telescopic group with the interpositioning of coupling-uncoupling groups;
wherein both said at least one upper telescopic group and said at least one lower telescopic group comprise a first section and a second section that are destined for being internally coupled with each other, wherein said second section is slidingly arranged internally with respect to the first section and is adjustable in position with respect to the same, once said first section has been fixed to the plane of the ceiling and to the plane of the floor respectively;
wherein each of said coupling-uncoupling groups comprises a first female coupling element and a second male coupling element that are connected, one to said second section and the other to said partition panel and can be engaged with each other in rotation by releasable constraint members.

2. The system according to claim 1, wherein said first female coupling element comprises a recessed circular housing, and said second male coupling element comprises a plate structure from which a flat elongated rectangular T-shaped extension protrudes for the engagement in said housing by rotation.

3. The system according to claim 2, wherein said first female coupling element comprises a plate structure, in a base, said recessed circular housing, with a peripheral opening for access to the housing and provided with a perimetric edge protruding inwardly, and in said second male coupling element, said flat T-shaped extension is suitable for passing through the above-mentioned peripheral opening for access to the housing by its shorter side, so as to enter the same and, by said rotation, position itself blocked in its interior with its longer side beneath said perimetric edge.

4. The system according to claim 1, wherein said first section and a second section are U-shaped in section and said first section in a central portion connecting the two sides of the U, within the section, has and carries a longitudinal shaped housing with curved ends, suitable for slidingly receiving in its interior plates carrying and axially constraining, free to rotate, externally threaded pins, which protrude perpendicular to each plate and are inserted in threaded holes produced in a solid central portion of said second section.

5. The system according to claim 4, wherein said externally threaded pins are provided with a blind hole shaped for receiving an Allen key which allows their rotation in screwing and/or unscrewing with respect to threaded holes in said second section.

6. The system according to claim 1, wherein a covering plate is further provided positioned above said second section of said telescopic coupling groups which provides a series of pass-through openings which each allow the passage of a first female coupling element.
